(19) United States
(12) Patent Application Publication
(10) Pub. No.: US 2026/0010298 A1
(43) Pub. Date: Jan. 8, 2026

(54) SMART GUARD INFLIGHT STORAGE AREA NETWORK (SAN) SHIELD USING EXPLAINABILITY GENERATIVE ARTIFICIAL INTELLIGENCE

(71) Applicant: BANK OF AMERICA CORPORATION, Charlotte, NC (US)

(72) Inventors: Anurajam Rajagopalan, Chennai, Tamil Nadu (IN); Manjula B., Chennai, Tamil Nadu (IN); Rammohan Chiliveri, Concord, NC (US); Vipin Kumar, Gurugram, Haryana (IN); Poornima Mani, Chennai, Tamil Nadu (IN)

(73) Assignee: BANK OF AMERICA CORPORATION, Charlotte, NC (US)

(21) Appl. No.: 18/765,233

(22) Filed: Jul. 6, 2024

(51) Int. Cl. G06F 3/06

(52) U.S. Cl. CPC G06F 3/0622; G06F 3/0655; G06F 3/067

(57) ABSTRACT

Data blocks that are being transmitted via a Storage Area Network are provided inflight security, in the form of cryptography that is dynamically generated and applied while the data is being transferred to the SAN. The complexity/type of cryptography that is generated and applied is based, at least, on the level of confidentiality/sensitivity of individual data elements in a data block. Gen AI models are implemented that have been trained to identify confidential data elements and, in response, categorize the confidential data elements into confidentiality sectors that are based on the level of transmission security required. Once the confidential data elements have been categorized/sectored, the Gen AI generates (i) cryptographic logic for each confidentiality sector, which is subsequently applied and (ii) a smart contract that includes the generated cryptographic logic and is exchanged between the source and destination, which is enabled through authenticity of user information embedded in the smart contract.

### FIELD OF THE INVENTION

The present invention is generally directed to data security and, more specifically, a system for inflight encryption of data being transferred using a Storage Area Network in which the encryption logic is generated by generative Artificial Intelligence based, at least, on the level of confidentiality/privacy surrounding the data.

### BACKGROUND

Storage Area Network (SAN) is a specialized, high-speed network that provides block-level storage access to servers. SANs offer fast data transfer rates, often using Fiber Channel technology, which is crucial for applications requiring high throughput and low latency. SANs also allow for centralized management of storage resources making it easier to allocate and manage storage space efficiently. In addition, SANs can easily be scaled by adding more storage devices and switches without disrupting existing services. Moreover, by offloading storage traffic from a main network to a dedicated SAN, the overall performance of the main network can be improved.

SANs are commonly used in large enterprises where a need exists for high-performance, high-availability storage solutions. In addition, SANs support virtualized environments, such as cloud storage and the like, by providing the necessary performance and storage management capabilities for virtual machined. Further, SANs are highly beneficial for database applications that require fast read and write operations and high transaction throughput.

For example, in a large enterprise, a SAN might be used to connect several servers to a centralized storage system. This allows the servers to access shared storage resources efficiently. For instance, a database server and a file server might both store their data on the same SAN, allowing for better utilization of storage resources and simpler data management. Additionally, backups of critical data can be performed over the SAN to a separate backup storage system, ensuring data protection and quick recovery in case of hardware failure.

Network snooping, also commonly referred to as network sniffing or packet sniffing, is the practice of intercepting and monitoring data packets as they travel across a network. This can be done using specialized software or hardware called packet sniffers. A packet sniffer captures data packets on a network. The data packets contain data being transmitted between devices, including source and destination addresses, protocols, and the actual data payload. Once captured, the packets can be analyzed to extract information. From a malicious perspective, network snooping results in interception of sensitive data, such as passwords, personal data and/or otherwise confidential information related to the enterprise.

SANs are especially susceptible to network snooping and sensitive/confidential data may be exposed since every client computer uses the same set of storage devices. While encryption of private/confidential data can used to deter network snooping, using the same cryptographic logic across the same set of storage devices still poses a security concern. Moreover, while mapping or zoning can be used in SAN as a security measure, such zoning may be difficult during critical enterprise period of time, especially zoning or any orphaned ports (i.e., ports previously designated for a zone but no longer currently active) during critical periods of time.

Therefore, a need exists to develop systems, computerized methods and the like that will ensure that sensitive/confidential data is securely transmitted in a SAN framework. The desired systems, computerized methods, and the like should take into account the level of privacy/confidentiality of the data in determining the complexity of the security mechanism applied thereto. Moreover, the security measures that are taken should be seamless and not intrusive to the source and destination involved in the data transfer process.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing for inflight (i.e., during actual transmission) security of data that is being transmitted/transferred via a Storage Area Network (SAN). Security is provided by cryptography that is dynamically generated and applied while the data is being transferred to the SAN. Moreover, the complexity of the cryptography that is generated and applied is based, at least, on the level of confidentiality/sensitivity of individual data elements in a data block.

The invention relies on Generative Artificial Intelligence (Gen AI) models that have been trained to identify confidential data elements and, in response, categorize each of the confidential data elements into confidentiality sectors that are based on the level of transmission security required of the confidential data elements (i.e., the level or degree of confidentiality/privacy associated with the data elements). Once the confidential data elements have been categorized/sectored, the Gen AI generates cryptographic logic for each confidentiality sector. In this regard, individual cryptographic logic (i.e., encryption and decryption logic) is generated for each confidentiality sector so that the complexity of the cryptography varies based on the level of confidentiality/privacy associated with the confidentiality sector. The level of confidentiality may be based on many factors, including but not limited to, the sensitivity of the data, the deployment environment in which the data is to used in, the volume of the overall data set and/or confidential data, the frequency at which this data set gets transmitted, the sending and/or receiving entities, the perils associated with the transmission and the like.

Moreover, the Gen AI is configured to generate a smart contract that includes the generated cryptographic logic and is exchanged between the source and destination (i.e., the data sending entity and the data receiving entity), which is enabled through authenticity of user information embedded in the smart contract. In this regard, each time data gets transmitted, Gen AI generates a new cryptographic logic and an associated smart contract as a means for keeping the security levels at a heightened level.

In additional embodiments of the invention, the Gen AI is further defined as explainability Gen AI that is configured to generate explanations as to how the confidential data elements were identified, how the confidential data elements were categorized and how and/or why the cryptographic logic was generated for a specific confidentiality sector. In such embodiments of the invention, the explanations are included in the smart contract so that both the data sending and data receiving entities have access to the explanations. Explanations are instrumental in overcoming concerns related to the use of generative AI and ensuring that trusted decision-making went into the overall security process (i.e., identifying confidential data element, categorizing confidential data elements, and generating cryptographic logic that is aligned with the level of security required on a given confidentiality sector).

A system for inflight security of data transmitted via a Storage Area Network defines first embodiments of the invention. The system includes a Storage Area Network (SAN), which includes a plurality of storage devices. The system additionally includes a first computing platform including a first memory and one or more first computing processor devices in communication with the first memory. The first memory stores at least one generative Artificial Intelligence (Gen AI) model that is executable by at least one of the one or more first computing processor devices. The Gen AI model(s) is trained and configured to receive, during data transmission from a sending entity to a receiving entity, a data block from amongst a plurality of data blocks forming a data set and including a plurality of data elements. Further, the Gen AI model(s) is configured to identify confidential data elements from amongst the plurality of data elements and categorize each of the confidential data elements into one of a plurality of confidentiality sectors. Each of the confidentiality sectors distinguishable from each other by a different level of transmission protection required. In response to confidential data element categorization, the Gen AI model(s) are configured to generate, for each of the plurality of confidentiality sectors, cryptographic logic that is configured to encrypt and decrypt each of the confidential data elements in a corresponding confidentiality sector. In addition, the Gen AI model(s) are configured to generate a smart contract exchangeable between the receiving entity and sending entity. The smart contract includes, at least, the cryptographic logic for each of the plurality of confidentiality sectors.

The system additionally includes a second computing platform including a second memory and one or more second computing processor devices in communication with the second memory. The second stores a cryptographic platform that receives and stores in the second memory the cryptographic logic and is configured to receive, during the data transmission from the sending entity to the receiving entity, the data block and encrypt the confidential data elements in the data block using the cryptographic logic specific to the confidentiality sector in which each confidential data element has been categorized in. In response to encrypting the confidential data elements, the cryptography platform is configured to transmit the data block including the encrypted confidential data elements to the SAN for storage in one or more of the plurality of storage devices prior to transmission to the receiving entity.

In specific embodiments of the system, the at least one generative AI model includes at least one explainability generative AI model. In such embodiments of the system, the least one explainability generative AI model is further configured to generate one or more explanations for at least one of (i) why confidential data elements were categorized in a corresponding one the plurality of confidentiality sectors and (ii) how and why the cryptographic logic was generated for each of the plurality of confidentiality sectors. In related embodiments of the system, the at least one generative AI model is further configured to generate the smart contract that includes the one or more explanations.

In further specific embodiments of the system, the at least one generative AI model is further configured to generate the cryptographic logic based on at least one (i) an overall volume of data elements in the data block, and (ii) a volume of confidential data elements in a corresponding confidentiality sector. While in other related embodiments of the system, the at least one generative AI model is further configured to generate the cryptographic logic based on a deployment environment in which the data set is to be deployed by the receiving entity.

In other specific embodiments the system further includes a distributed trust computing network comprising a plurality of nodes that are decentralized. Each node having a third memory and one or more third processing devices in communication with the third memory. The third memory of the nodes is configured to store a distributed ledger comprising one or more data blocks. One of the data block(s) stores the smart contract after validation through consensus of at least two of the plurality of nodes.

In still further embodiments of the system, the data elements from amongst the plurality of data elements not identified as confidential data elements are not encrypted using the cryptographic logic. In such embodiments of the system, the data block that is stored in the storage device(s) of the SAN includes the encrypted confidential data elements and other unencrypted data elements.

Moreover, in further specific embodiments of the system, the smart contract further includes cryptographic keys for the cryptographic logic. In such embodiments of the system, upon receipt of the data set by the receiving entity, the receiving entity accesses the smart contract to retrieve one or more of the cryptographic keys and applies the one or more cryptographic keys to the data set to decrypt the encrypted confidential data elements in the data set.

A computer-implemented method for inflight security of data transmitted via a Storage Area Network defines second embodiments of the invention. The computer-implemented method is executed by one or more computing device processors. The method includes receiving, at one or more generative AI models during data transmission from a sending entity to a receiving entity, a data block from amongst a plurality of data blocks comprising a data set. The data block includes a plurality of data elements. The computer-implemented method further includes identifying, by the one or more generative AI models, confidential data elements from amongst the plurality of data elements and categorizing, by the one or more generative AI models, each of the confidential data elements into one of a plurality of confidentiality sectors. Each of the confidentiality sectors distinguishable from each other by a different level of transmission protection required. In response to categorizing the confidential data elements, the method includes generating, by the one or more generative AI models (i) for each of the plurality of confidentiality sectors, cryptographic logic that is configured to encrypt and decrypt each of the confidential data elements in a corresponding confidentiality sector and (ii) a smart contract exchangeable between the receiving entity and sending entity, wherein the smart contract includes the cryptographic logic for each of the plurality of confidentiality sectors. Further, the method includes encrypting the confidential data elements in the data block using the cryptographic logic specific to the confidentiality sector in which each confidential data element has been categorized in and transmitting the data block including the encrypted confidential data elements to a Storage Area Network for storage in one or more of the plurality of storage devices prior to transmission to the receiving entity.

In specific embodiments of the computer-implemented method, the one or more generative AI models include at least one explainability generative AI model and the method further includes generating, by the at least one explainability generative AI model, one or more explanations for at least one of (i) why confidential data elements were categorized in a corresponding one the plurality of confidentiality sectors and (ii) how and why the cryptographic logic was generated for each of the plurality of confidentiality sectors. In related embodiments of the method, generating the smart contract further includes generating the smart contract, such that the smart contract further includes the one or more explanations.

In still further specific embodiments of the computer-implemented method, generating the cryptographic logic further includes generating the cryptographic logic based on at least one (i) an overall volume of data elements in the data block, and (ii) a volume of confidential data elements in a corresponding confidentiality sector. While in other related embodiments of the computer-implemented method, generating the cryptographic logic further includes generating the cryptographic logic based on a deployment environment in which the data set is to be deployed by the receiving entity.

In additional specific embodiments of the computer-implemented method, generating the smart contract further includes generating the smart contract that further includes cryptographic keys for the cryptographic logic, such that upon receipt of the data set by the receiving entity, the receiving entity accesses the smart contract to retrieve one or more of the cryptographic keys and applies the one or more cryptographic keys to the data set to decrypt the encrypted confidential data elements in the data set.

A computer program product including a non-transitory computer-readable medium defines third embodiments of the invention. The non-transitory computer-readable medium includes sets of codes for causing one or more computing devices to receive, at one or more generative AI models during data transmission from a sending entity to a receiving entity, a data block from amongst a plurality of data blocks comprising a data set, the data block comprising a plurality of data elements. The sets of codes further include a sets of code for causing the computer device(s) to identify, by the one or more generative AI models, confidential data elements from amongst the plurality of data elements and categorize, by the one or more generative AI models, each of the confidential data elements into one of a plurality of confidentiality sectors, each of the confidentiality sectors distinguishable from each other by a different level of transmission protection required. Moreover, the sets of codes further cause the computing device(s) to generate, by the one or more generative AI models (i) for each of the plurality of confidentiality sectors, cryptographic logic that is configured to encrypt and decrypt each of the confidential data elements in a corresponding confidentiality sector and (ii) a smart contract exchangeable between the receiving entity and sending entity. The smart contract includes the cryptographic logic for each of the plurality of confidentiality sectors. Further, the Sets of codes further cause the computing device(s) to encrypt the confidential data elements in the data block using the cryptographic logic specific to the confidentiality sector in which each confidential data element has been categorized in and transmit the data block including the encrypted confidential data elements to a Storage Area network for storage in one or more of the plurality of storage devices prior to transmission to the receiving entity.

In specific embodiments of the computer program product, the one or more generative AI models includes at least one explainability generative AI model and the sets of codes further include a set of codes configured to cause the one or more computing devices to generate, by the at least one explainability generative AI model, explanations for at least one of (i) why confidential data elements were categorized in a corresponding one the plurality of confidentiality sectors and (ii) how and why the cryptographic logic was generated for each of the plurality of confidentiality sectors. In related embodiments of the computer program product, the set of codes for causing the one or more computing devices to generate the smart contract are further configured to cause the one or more computing devices to generate the smart contract that includes the one or more explanations.

In additional specific embodiments of the computer program product, the set of codes for causing the computing device(s) to generate the cryptographic logic are further configured to cause the one or more computing devices to generate the cryptographic logic based on at least one (i) an overall volume of data elements in the data block, and (ii) a volume of confidential data elements in a corresponding confidentiality sector. In related embodiments of the computer program product, the set of codes for causing the one or more computing devices to generate the cryptographic logic are further configured to cause the computing device(s) to generate the cryptographic logic based on a deployment environment in which the data set is to be deployed by the receiving entity.

Moreover, in further specific embodiments of the computer program product, the set of codes for causing the computing device(s) to generate the smart contract are further configured to cause the computing device(s) to generate the smart contract, wherein the smart contract further includes cryptographic keys for the cryptographic logic, wherein upon receipt of the data set by the receiving entity, the receiving entity accesses the smart contract to retrieve one or more of the cryptographic keys and applies the one or more cryptographic keys to the data set to decrypt the encrypted confidential data elements in the data set.

Thus, according to embodiments of the invention, which will be discussed in greater detail below, the present invention addresses needs and/or achieves other advantages by providing inflight security to data blocks that are being transmitted via a Storage Area Network (SAN). The security is in the form of cryptography that is dynamically generated and applied while the data is being transferred to the SAN. The complexity/type of cryptography that is generated and applied is based, at least, on the level of confidentiality/sensitivity of individual data elements in a data block. Gen AI models are implemented that have been trained to identify confidential data elements and, in response, categorize the confidential data elements into confidentiality sectors that are based on the level of transmission security required. Once the confidential data elements have been categorized/sectored, the Gen AI generates (i) cryptographic logic for each confidentiality sector, which is subsequently applied and (ii) a smart contract that includes the generated cryptographic logic and is exchanged between the source and destination, which is enabled through authenticity of user information embedded in the smart contract. Further, the Gen AI may be explainability Gen AI capable of generating explanations for individual steps in the security process and providing such explanations in the smart contract.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 is a schematic/block diagram of a system for infight security of data transmitted via a Storage Area Network (SAN), in accordance with embodiments of the present invention;

FIG. 2 is a schematic/block diagram of an alternate system for infight security of data transmitted via a Storage Area Network (SAN), in accordance with embodiments of the present invention;

FIG. 3 is a block diagram of a computing platform including explainability generative artificial intelligence (Gen AI) models, in accordance with alternate embodiments of the present invention;

FIG. 4 is a schematic/flow diagram of a methodology for infight security of data transmitted via a Storage Area Network (SAN), in accordance with embodiments of the invention;

FIG. 5 is a swim lane diagram illustrating methodologies for infight security of data transmitted via a Storage Area Network (SAN), in accordance with embodiments of the invention; and

FIG. 6 is a flow diagram of a method for infight security of data transmitted via a Storage Area Network (SAN), in accordance with embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as a system, a method, a computer program product, or a combination of the foregoing. Accordingly, embodiments of the present invention may take the form of an entirely hardware embodiment, an entirely software embodiment (including firmware, resident software, micro-code, a.), or an embodiment combining software and hardware aspects that may be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted, or unscripted programming language such as JAVA, PERL, SMALLTALK, C++, PYTHON, or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or systems. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

“Computing platform” or “computing device” as used herein refers to a networked computing device within the computing system. The computing platform may include a processor, a non-transitory storage medium (i.e., memory), a communications device, and a display. The computing platform may be configured to support user logins and inputs from any combination of similar or disparate devices. Accordingly, the computing platform includes servers, personal desktop computer, laptop computers, mobile computing devices and the like.

Thus, systems, apparatus, and methods are described in detail below that provide for inflight (i.e., during actual transmission) security of data that is being transmitted/transferred via a Storage Area Network (SAN). Security is provided by cryptography that is dynamically generated and applied while the data is being transferred to the SAN. Moreover, the complexity of the cryptography that is generated and applied is based, at least, on the level of confidentiality/sensitivity of individual data elements in a data block.

The invention relies on Generative Artificial Intelligence (Gen AI) models that have been trained to identify confidential data elements and, in response, categorize each of the confidential data elements into confidentiality sectors that are based on the level of transmission security required of the confidential data elements (i.e., the level or degree of confidentiality/privacy associated with the data elements). Once the confidential data elements have been categorized/sectored, the Gen AI generates cryptographic logic for each confidentiality sector. In this regard, individual cryptographic logic (i.e., encryption and decryption logic) is generated for each confidentiality sector so that the complexity of the cryptography varies based on the level of confidentiality/privacy associated with the confidentiality sector. The level of confidentiality may be based on many factors, including but not limited to, the sensitivity of the data, the deployment environment in which the data is to used in, the volume of the overall data set and/or confidential data, the frequency at which this data set gets transmitted, the sending and/or receiving entities, the perils associated with the transmission and the like.

Moreover, the Gen AI is configured to generate a smart contract that includes the generated cryptographic logic and is exchanged between the source and destination (i.e., the data sending entity and the data receiving entity), which is enabled through authenticity of user information embedded in the smart contract. In this regard, each time data gets transmitted, Gen AI generates a new cryptographic logic and an associated smart contract as a means for keeping the security levels at a heightened level.

In additional embodiments of the invention, the Gen AI is further defined as explainability Gen AI that is configured to generate explanations as to how the confidential data elements were identified, how the confidential data elements were categorized and how and/or why the cryptographic logic was generated for a specific confidentiality sector. In such embodiments of the invention, the explanations are included in the smart contract so that both the data sending and data receiving entities have access to the explanations. Explanations are instrumental in overcoming moral concerns related to the use of generative AI and ensuring that trusted decision-making went into the overall security process (i.e., identifying confidential data element, categorizing confidential data elements, and generating cryptographic logic that is aligned with the level of security required on a given confidentiality sector).

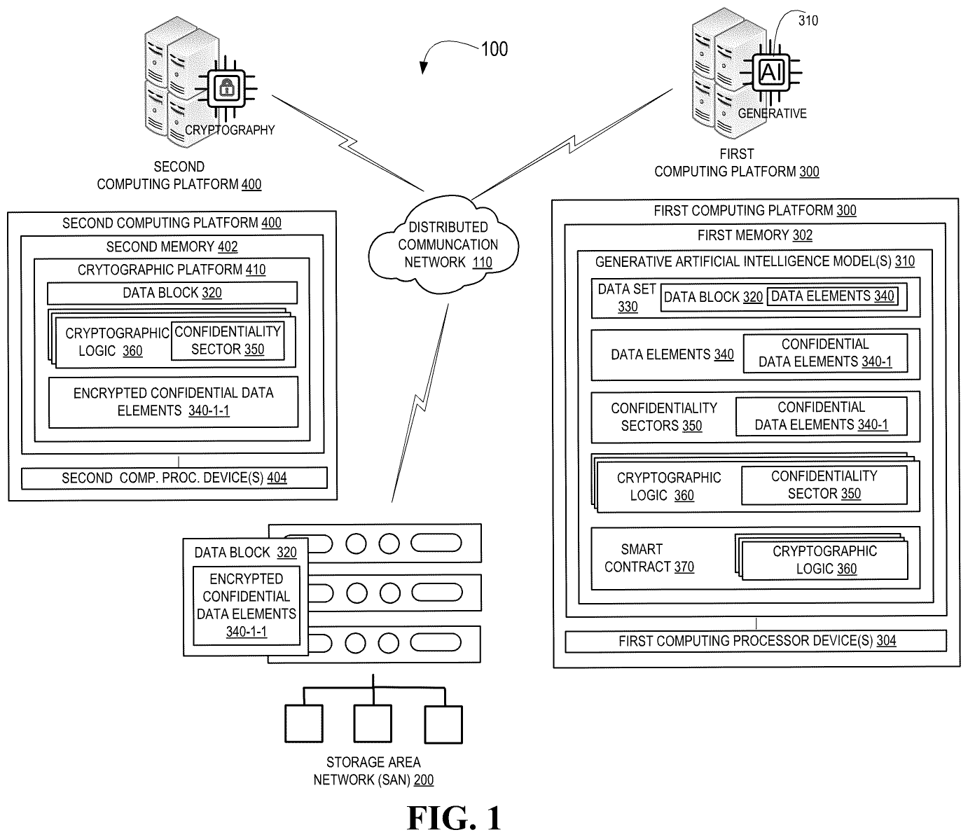

Referring to FIG. 1, a schematic/block diagram is presented of an exemplary system 100 for infight security of data transmitted via a Storage Area Network (SAN), in accordance with embodiments of the invention. System 100 is operable within a distributed communication network 110 which may comprise the Internet, one or more intranets, cellular network(s) or the like. The system includes a Storage Area Network 200 that includes a plurality of storage devices, such as, disk arrays, tape libraries, solid-state drives and the like, as well as switches and the like to facilitate the communication amongst the storage devices. In specific embodiments of the invention, at least a portion (i.e., hybrid) or an entirely of the SAN is a computing cloud-based SAN.

System 100 additionally includes first computing platform 300 having a first memory 302 and one or more first computing processor devices 304 in communication with the first memory 302. As shown in FIG. 1, first computing platform 300 may comprise multiple computing devices, such as servers/storage units and the like. First memory 302 stores one or more Generative Artificial Intelligence (Gen AI) models 310 which are executable by one or more of the computing processor device(s) 304. Gen AI models 310 are trained and configured to receive, inflight (i.e., during transmission from a data sending entity to the SAN 200), a data block 320 from amongst a plurality of data blocks that comprise a data set 330. The data block includes a plurality of data elements 340. In response to data block receipt, Gen AI model(s) 310 is trained and configured to identify confidential data elements 340-1 from amongst the plurality of data elements 340. Confidential data as used herein may include, but is not limited to, any data that is classified as sensitive, private or restrictive to an individual or enterprise, such as personal data, financial data, health data, employment data, intellectual property, legal data, authentication credentials or the like. In response to identifying confidential data elements 340-1, Gen AI model(s) 310 is trained and configured to categorize each of the confidential data elements 340-1 into one of a plurality of confidentiality sectors 350. Each confidentiality sector is distinguishable from one another by a different level of transmission protection required of the confidential data elements stored therein. The confidentiality sectors may be predefined or dynamically defined depending on the type of confidential data elements to be stored therein.

In response to identifying confidential data elements 340-1 and categorizing the confidential data elements in confidentiality sectors 350, Gen AI model(s) 310 is trained and configured to generate, for each of the confidentiality sectors 350, cryptographic logic 360 (i.e., encryption and decryption algorithms/logic, as well as associated encryption/decryption keys) that is configured to encrypt and decrypt the confidential data elements 340-1 included within a corresponding confidentiality sector 350. In this regard, each confidentiality sector 350 has its own unique cryptographic logic 360, such that the confidential data elements 340-1 contained therein will be encrypted/decrypted with their own unique encryption/decryption algorithms/logic. In response to generating cryptographic logic 360, Gen AI model(s) 310 are trained and configured to generate a smart contract 340 that is exchangeable between the data receiving entity and the data sending entity and includes, at a minimum, the cryptographic logic 360 for each of the confidentiality sectors 350. In specific embodiments of the invention, the smart contract 340 is generated after all of the data blocks 320 in the data set 330 have undergone Gen AI model 310 processing, while in other embodiments of the invention individual smart contracts 340 will be generated for each data block 320 in the data set 330.

System 100 additionally includes second computing platform 400 having a second memory 402 and one or more second computing processor devices 404 in communication with the first memory 402. As shown in FIG. 1, second computing platform 400 may comprise multiple computing devices, such as servers/storage units and the like. Second memory 402 stores cryptographic platform 410 that receives and stores in second memory 404 the cryptographic logic 360 or otherwise accesses the cryptographic logic 360 (such as from the smart contract 340 or the like). Cryptographic platform 410 is configured to receive, inflight (i.e., during data transmission from the data sending entity to the SAN), the data block 320 and, in response, encrypt the confidential data elements 340-1 in the data block 320 using the cryptographic logic 360 specific to the confidentiality sector 350 in which each of the confidential data elements 340-1 has been categorized/sectored in. It should be noted that data elements 340 in the data block 320 that have not been identified as confidential data elements 340-1 and thus have not been categorized into a confidentiality sector 350 are not subjected to encryption and will remain in the clear. In response to encryption, cryptographic platform 410 is configured to transmit/transfer the data block 320 including the encrypted confidential data elements 340-1-1 to the SAN 200 for storage in one or more of aforementioned storage devices prior to transmission/transfer to the data receiving entity.

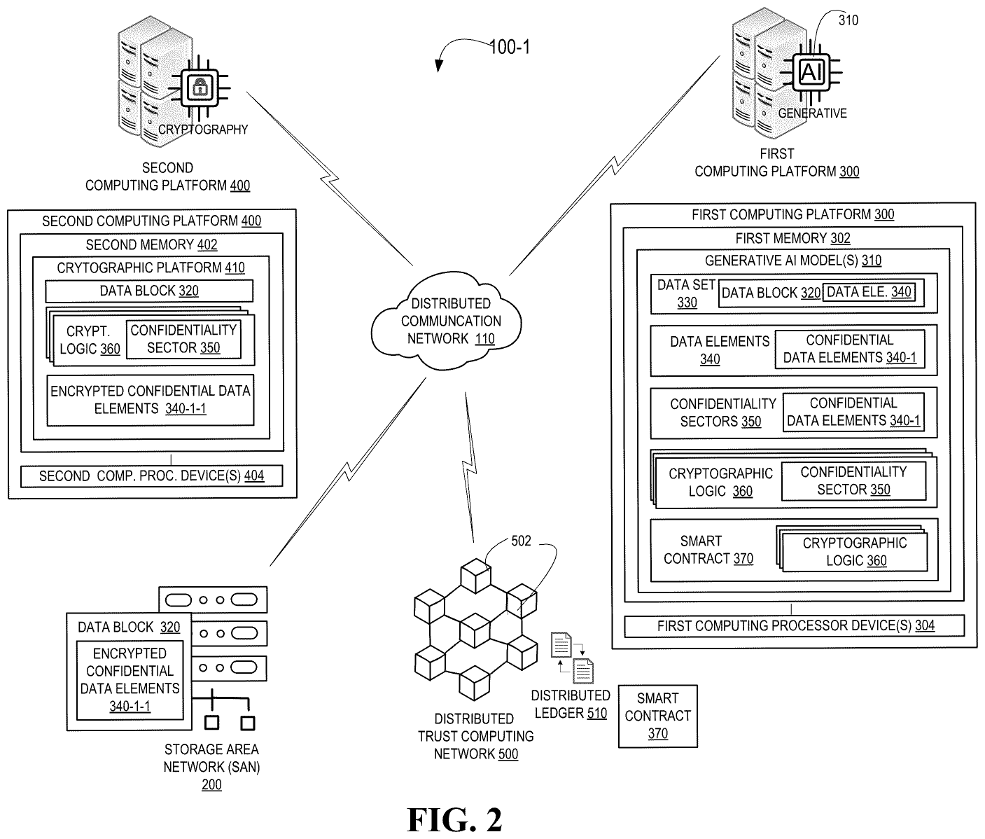

Referring to FIG. 2, a block diagram is depicted of an alternative system 100-1 for inflight security of data transmitted via a Storage Area Network (SAN), in accordance with embodiments of the invention. The system includes the same SAN 200, first computing platform 300 including Gen AI models 310 and second computing platform 400 including cryptographic platform 410 as the system 100 shown in and described in relation to FIG. 1. Therefore, for the sake of brevity such elements will not be discussed herein in relation to FIG. 2. Additionally, system 100-1 includes distributed trust computing network 500, such as a blockchain or the like, which includes a plurality of decentralized nodes 502. Each node 505 includes a third memory (not shown in FIG. 2) and at least one third computing processor device (not shown in FIG. 2) in communication with the third memory. The third memory is configured to store a distributed ledger 510 that includes one or more blocks (not shown in FIG. 2). In accordance with the present invention, one or more of the blocks stores the smart contract 340 after validation of the smart contract 340 through consensus of at least two of the nodes. Once stored on the distributed ledger 510, the smart contract including the cryptographic logic (i.e., encryption/decryption algorithms/logic as well as corresponding encryption/encryption keys) are accessible to the data sending entity, the data receiving entity and the any cryptographic platforms, such as cryptographic platform 410 for subsequent encryption and/or decryption of data blocks 320. In alternate embodiments of the invention, the entire smart contract 340 or portions thereof may be stored external to the distributed trust computing network 500 (i.e., off-chain) or the like.

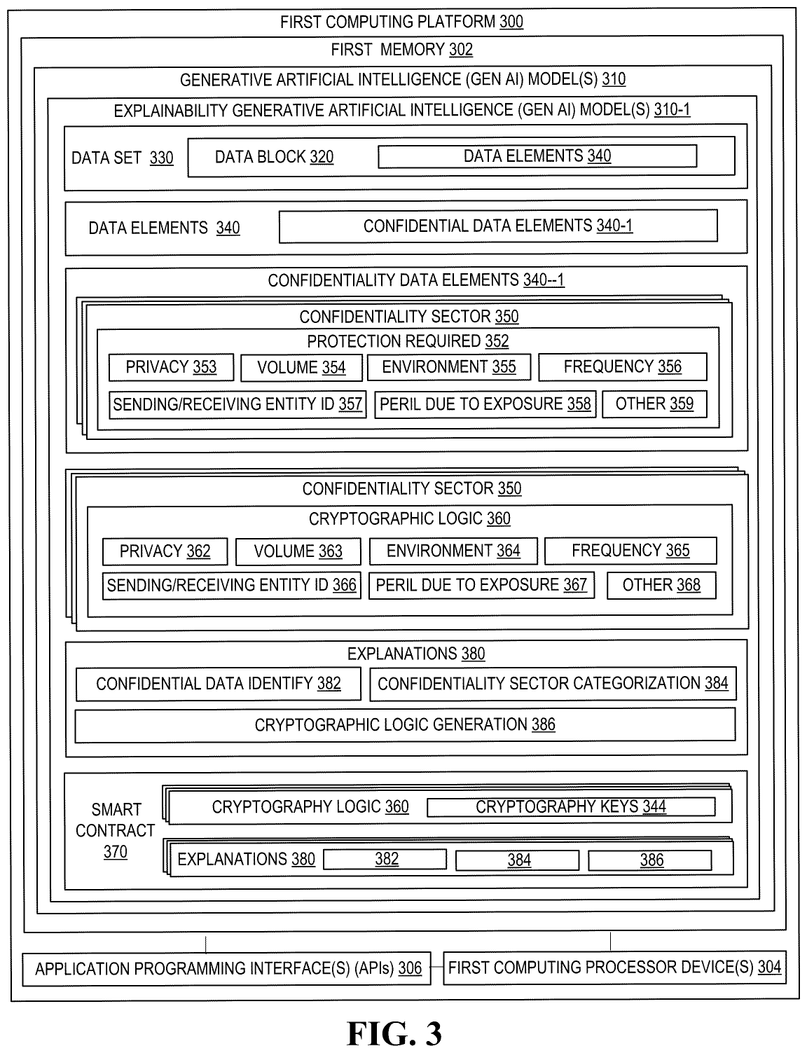

Referring to FIG. 3, a block diagram is depicted of first computing platform 300 highlighting various alternate embodiments of the Gen AI model 310, in accordance with embodiments of the present invention. As previously discussed in relation to FIG. 1, first computing platform 300 may comprise one or multiple computing devices, such as servers, storage devices or the like. As further previously discussed, first computing platform 300 includes first memory 302, which may comprise volatile and/or non-volatile memory, such as read-only memory (ROM) and/or random-access memory (RAM), EPROM, EEPROM, flash cards, or any memory common to computing platforms. Moreover, first memory 302 may comprise cloud storage, such as provided by a cloud storage service and/or a cloud connection service.

Further, first computing platform 300 includes one or more first computing processor devices 304, which may be an application-specific integrated circuit (“ASIC”), or other chipset, logic circuit, or other data processing device. First computing processor device(s) 304 may execute one or more application programming interface (APIs) 306 that interface with any resident programs, such as Gen AI models 310 or the like, stored in first memory 302 of first computing platform 300 and any external programs. First computing platform 300 may include various processing sub-systems (not shown in FIG. 3) embodied in hardware, firmware, software, and combinations thereof, that enable the functionality of first computing platform 300 and the operability of first computing platform 300 on a distributed communication network 110 (shown in FIG. 1). For example, processing sub-systems allow for initiating and maintaining communications and exchanging data with other networked devices. For the disclosed aspects, processing sub-systems of first computing platform 300 may include any processing sub-system portion used in conjunction with Gen AI models 310 and related tools, routines, sub-routines, applications, sub-applications, sub-modules thereof.

In specific embodiments of the present invention, first computing platform 300 additionally includes a communications module (not shown in FIG. 3) embodied in hardware, firmware, software, and combinations thereof, that enables electronic communications between components of first computing platform 300 and other networks and network devices. Thus, communication module may include the requisite hardware, firmware, software and/or combinations thereof for establishing and maintaining a network communication connection with one or more devices and/or networks.

As previously discussed in relation to FIG. 1, first memory 302 of first computing platform 300 stores one or more Gen AI models 310. In specific embodiments of the invention, Gen AI model 310 is further defined as an Explainability Gen AI model 310-1 configured to generate explanations 380 for the processing conducting by the model. Gen AI models 310 are trained and configured to receive, inflight (i.e., during transmission from a data sending entity to the SAN 200), a data block 320 from amongst a plurality of data blocks that comprise a data set 330. The data block includes a plurality of data elements 340.

In response to data block receipt, Gen AI model(s) 310 is trained and configured to identify confidential data elements 340-1 from amongst the plurality of data elements 340. Confidential data as used herein may include, but is not limited to, any data that is classified as sensitive, private or restrictive to an individual or enterprise, such as personal data, financial data, health data, employment data, intellectual property, legal data, authentication credentials or the like.

In response to identifying confidential data elements 340-1, Gen AI model(s) 310 is trained and configured to categorize each of the confidential data elements 340-1 into one of a plurality of confidentiality sectors 350. Each confidentiality sector is distinguishable from one another by a different level of transmission protection 352 required of the confidential data elements stored therein. Transmission protection may be based on, but is not limited to, privacy 353 associated with the confidential data, the volume 354 of the data (overall volume and/or confidential data volume, the deployment employment 355 in which the data is to be used, the frequency 356 in which similar data is transmitted, the data sending and/or receiving entity identity 357, the peril posed by exposure 358 of the data and any other 359 factors. The confidentiality sectors may be predefined or dynamically defined depending on the type of confidential data elements to be stored therein.

In response to identifying confidential data elements 340-1 and categorizing the confidential data elements in confidentiality sectors 350, Gen AI model(s) 310 is trained and configured to generate, for each of the confidentiality sectors 350, cryptographic logic 360 (i.e., encryption and decryption algorithms/logic, as well as associated encryption/decryption keys) that is configured to encrypt and decrypt the confidential data elements 340-1 included within a corresponding confidentiality sector 350. In this regard, each confidentiality sector 350 has its own unique cryptographic logic 360, such that the confidential data elements 340-1 contained therein will be encrypted/decrypted with their own unique encryption/decryption algorithms/logic. The cryptographic logic 360 by way of the assigned confidentiality sector or on its own may be based on the privacy 362 associated with the confidential data, the volume 363 of the data (overall volume and/or confidential data volume, the deployment employment 364 in which the data is to be used, the frequency 365 in which similar data is transmitted, the data sending and/or receiving entity identity 366, the peril posed by exposure 367 of the data and any other 368 factors.

As previously mentioned above, Explainability Gen AI model 310-1 configured to generate explanations 380 for the processing conducting by the model. These explanations may include, but are not limited to, confidential data element identification 382 (e.g., why a certain data element is deemed to be confidential), confidentiality sector categorization 384 (e.g., why a certain confidential data elements is categorized in a certain confidentiality sector) and cryptographic logic generation 386 (e.g., why and how specific cryptographic logic is generated).

In response to generating cryptographic logic 360, Gen AI model(s) 310 are trained and configured to generate a smart contract 340 that is exchangeable between the data receiving entity and the data sending entity and includes, at a minimum, the cryptographic logic 360 for each of the confidentiality sectors 350 and, in explainability Gen AI model 310-1 embodiments, the explanations 380 of how and/or why of confidential data element identification 382, confidentiality sector categorization 384 and/or cryptographic logic generation 386. In specific embodiments of the invention, the smart contract 340 is generated after all of the data blocks 320 in the data set 330 have undergone Gen AI model 310 processing, while in other embodiments of the invention individual smart contracts 340 will be generated for each data block 320 in the data set 330.

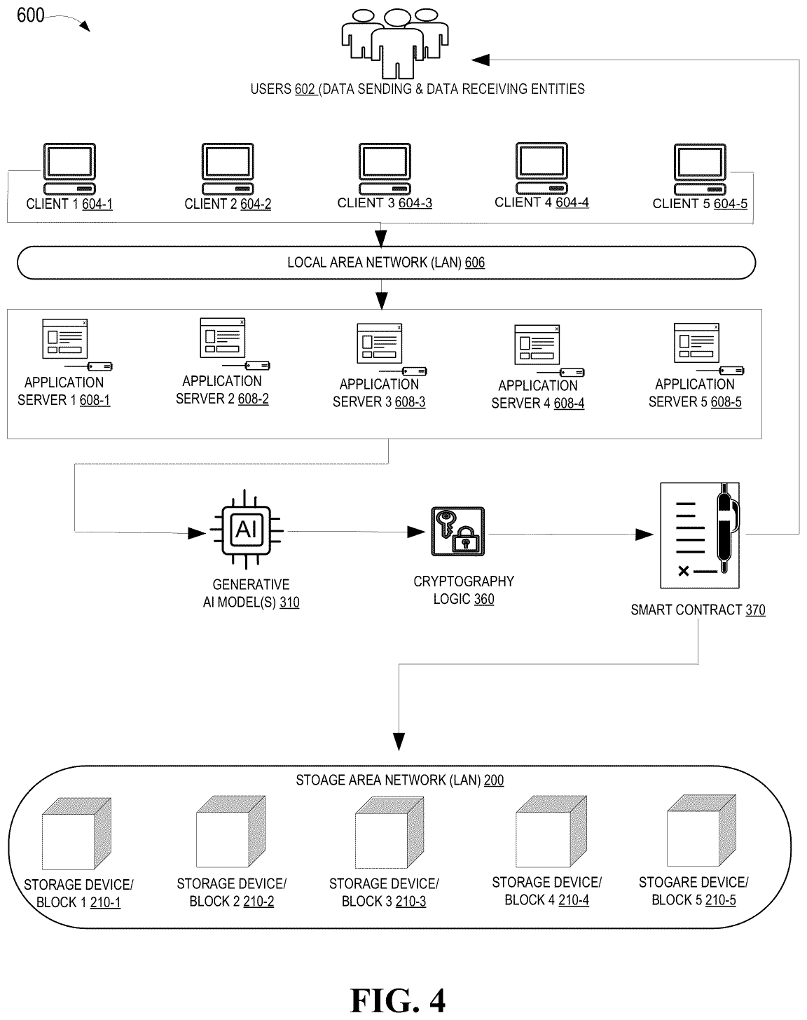

Referring to FIG. 4, a block/flow diagram is depicted of a methodology 600 for inflight security of data being transferred through a Rammohan, in accordance with embodiments of the present invention. Users 602 initiate data transfers in which client servers 604-1-604-5 transfer raw data via Local Area Network (LAN) 606 to application servers 608-1-608-5 for subsequent processing. Once processed the data, while in flight to the SAN 200, is subjected to generative AI model(s) 310 to (i) identify confidential data elements, (ii) categorize the identified confidential data elements are according to confidentiality sectors, and (iii) generate (i) cryptographic logic 360 for each confidentiality sector and (ii) a corresponding smart contract, which is exchanged between the users (i.e., data sending entity and data receiving entity). Once the cryptographic logic 360 is applied to encrypt the confidential data elements using the cryptographic logic 360 associated with the confidentiality sector is which the confidential data elements have been categorized in, the data is transferred to storage area network (SAN) for storage in storage devices 210-1-210-5.

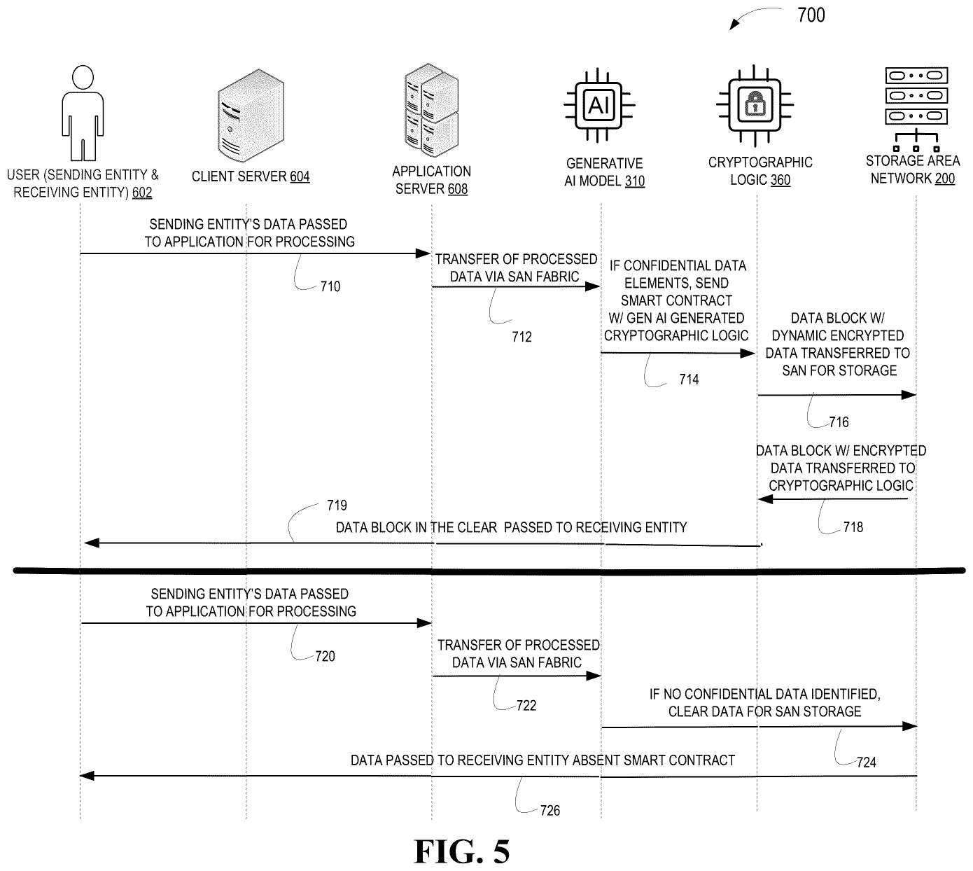

Referring to FIG. 5, swim-lane diagrams are presented for methodologies for inflight security of data being transmitted/transferred through a SAN, in accordance with embodiments of the present invention. At Event 710, data sending entity (i.e., user 602) initiates a data transfer process by sending data via client server 604 to application server 608, at which the data is processed according to the requirements of the data receiving entity (i.e., user 602). At Event 712, the processed data is transferred from the application server 608 to the generative AI model 310 at which (i) confidential data elements are identified, (ii) identified confidential data elements are categorized into confidentiality sectors and (iii) cryptographic logic 360 is generated for each confidentiality sector and a corresponding smart contract is generated and exchanged between the data sending party and data receiving party. At Event, since confidential data elements were identified in the data block, a smart contract is generated including the cryptographic logic and the cryptographic logic 360 is applied to the data block to encrypt the identified confidential data elements. At Event 716, the data block including the dynamically (i.e., while inflight) encrypted confidential data elements is transferred to the SAN for storage. At Event 718, the data is requested by the user 602 (i.e., data receiving entity) and dynamically decrypted (i.e., while inflight). In alternate embodiments of the invention, the data block with encrypted data is transmitted to the user 602 who accesses the smart contract to retrieve and apply the decryption logic and associated decryption keys. At Event 719, the data block is transferred to the user 602 (i.e., data receiving entity) in the clear.

At Event 720, data sending entity (i.e., user 602) initiates a data transfer process by sending other data via client server 604 to application server 608, at which the data is processed according to the requirements of the data receiving entity (i.e., user 602). At Event 722, the processed other data is transferred from the application server 608 to the generative AI model 310 at which (i) no confidential data elements are identified. Since no confidential data elements were identified, at Event 724, the other data is transferred directly to the SAN for storage. At Event 726, the data is transferred directly to the user 602 (data receiving entity) without a smart contract being generated by the Gen AI model(s) 310 nor exchanged between the data sending and data receiving entities/users 602.

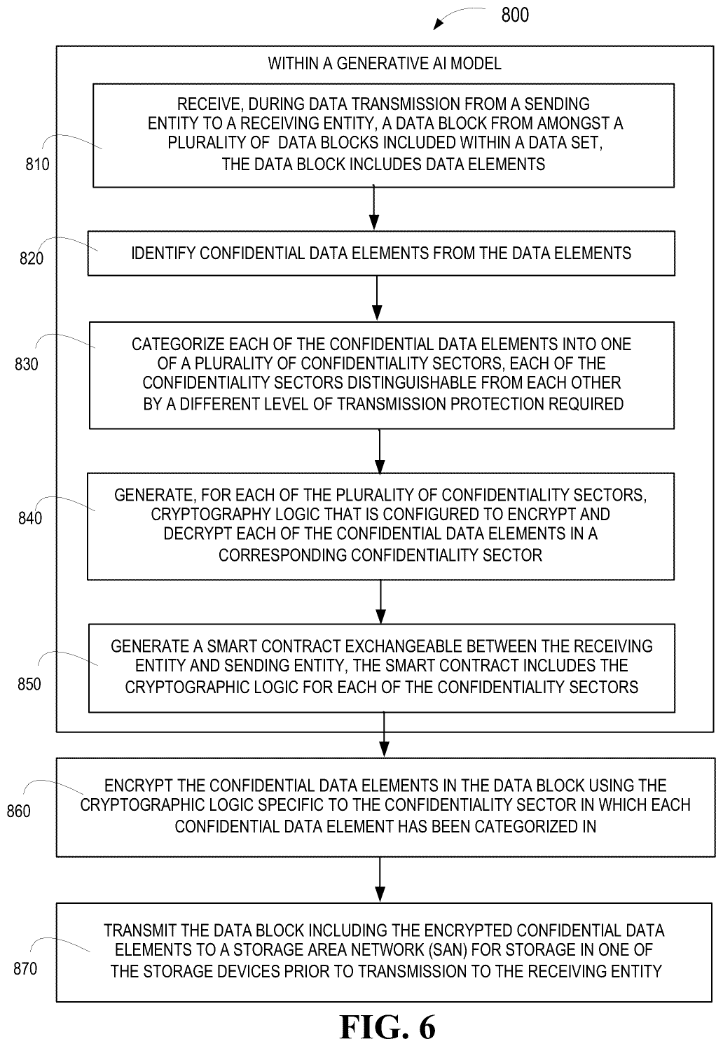

Referring to FIG. 6, a flow diagram is a depicted of a method 800 for inflight security of data being transmitted through a Storage Area Network (SAN), in accordance with embodiments of the present invention. At Event 810, a data block from amongst a plurality of data blocks forming a data set is received. The data block is received during transmission from a data sending entity to the SAN at one or more Generative AI (Gen AI) models, which may, in specific embodiments include Explainability Gen AI model(s). The data block includes a plurality of data elements.

In response to receiving the data block, at Event 820, the one or more generative AI models analyze the data elements to identify confidential data elements. In response to confidential data element identification, at Event 830, the Gen Ai model(s) categorize each of the confidential data elements into one of a plurality of different confidentiality sectors. Each of the confidentiality sectors are distinguishable from each other based at least of the level of transmission protection required of the confidential data elements contained therein.

In response to confidential data element categorization, at Event 840, the Gen AI model(s) generates cryptographic logic for each of the confidentiality sectors. The cryptographic logic is configured to encrypt and decrypt each of the confidential data elements in a corresponding confidentiality sector. In optional embodiments (not shown in FIG. 6) in which the Gen AI model(s) includes an Explainability Gen AI model, explanations are generated for the confidential data element identification, the confidentiality sector categorizations and/or the cryptographic logic.

In response to generating the cryptographic logic, at Event 850, the Gen AI generates a smart contract exchangeable between the receiving entity and sending entity. The smart contract includes the cryptographic logic for each of the plurality of confidentiality sectors and, in applicable embodiments of the invention, the explanations generated by the Explainability Gen Ai model(s).

At Event 860, the confidential data elements in the data block are encrypted using the cryptographic logic specific to the confidentiality sector in which each confidential data element has been categorized in, at Event 870, the data block including the encrypted confidential data elements are o the Storage Area Network (SAN) for storage in one or more of the plurality of storage devices prior to transmission to the data receiving entity.

Thus, as described in detail above, present embodiments of the invention include systems, methods, computer program products and/or the like that provide inflight security to data blocks that are being transmitted via a Storage Area Network (SAN). The security is in the form of cryptography that is dynamically generated and applied while the data is being transferred to the SAN. The complexity/type of cryptography that is generated and applied is based, at least, on the level of confidentiality/sensitivity of individual data elements in a data block. Gen AI models are implemented that have been trained to identify confidential data elements and, in response, categorize the confidential data elements into confidentiality sectors that are based on the level of transmission security required. Once the confidential data elements have been categorized/sectored, the Gen AI generates (i) cryptographic logic for each confidentiality sector, which is subsequently applied and (ii) a smart contract that includes the generated cryptographic logic and is exchanged between the source and destination, which is enabled through authenticity of user information embedded in the smart contract. Further, the Gen AI may be explainability Gen AI capable of generating explanations for individual steps in the security process and providing such explanations in the smart contract.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for inflight security of data transmitted via a Storage Area Network, the system comprising:
a Storage Area Network (SAN) comprising a plurality of storage devices; and
a first computing platform including a first memory and one or more first computing processor devices in communication with the first memory, wherein the first memory stores at least one generative Artificial Intelligence (AI) model that is executable by at least one of the one or more first computing processor devices and trained and configured to:
receive, during data transmission from a sending entity to the SAN, a data block from amongst a plurality of data blocks comprising a data set, the data block comprising a plurality of data elements,
identify confidential data elements from amongst the plurality of data elements,
categorize each of the confidential data elements into one of a plurality of confidentiality sectors, each of the confidentiality sectors distinguishable from each other by a different level of transmission protection required,
generate, for each of the plurality of confidentiality sectors, cryptographic logic that is configured to encrypt and decrypt each of the confidential data elements in a corresponding confidentiality sector, and
generate a smart contract exchangeable between the receiving entity and sending entity, wherein the smart contract includes the cryptographic logic for each of the plurality of confidentiality sectors; and
a second computing platform including a second memory and one or more second computing processor devices in communication with the second memory, wherein the second stores a cryptographic platform that receives and stores in the second memory the cryptographic logic and is configured to:
receive, during the data transmission from the sending entity to the receiving entity, the data block,
encrypt the confidential data elements in the data block using the cryptographic logic specific to the confidentiality sector in which each confidential data element has been categorized in, and
transmit the data block including the encrypted confidential data elements to the SAN for storage in one or more of the plurality of storage devices prior to transmission to the receiving entity.

2. The system of claim 1, wherein the at least one generative AI model includes at least one explainability generative AI model, and wherein the least one explainability generative AI model is further configured to generate one or more explanations for at least one of (i) why confidential data elements were categorized in a corresponding one the plurality of confidentiality sectors and (ii) how and why the cryptographic logic was generated for each of the plurality of confidentiality sectors.

3. The system of claim 2, wherein the at least one explainability generative AI model is further configured to generate the smart contract, wherein the smart contract further includes the one or more explanations.

4. The system of claim 1, wherein the at least one generative AI model is further configured to generate the cryptographic logic based on at least one (i) an overall volume of data elements in the data block, and (ii) a volume of confidential data elements in a corresponding confidentiality sector.

5. The system of claim 1, wherein the at least one generative AI model is further configured to generate the cryptographic logic based on a deployment environment in which the data set is to be deployed by the receiving entity.

6. The system of claim 1, further comprising a distributed trust computing network comprising a plurality of nodes that are decentralized, each node having a third memory and one or more third processing devices in communication with the third memory, wherein the third memory of the nodes is configured to store a distributed ledger comprising one or more data blocks, wherein one of the one or more data blocks stores the smart contract after validation through consensus of at least two of the plurality of nodes.

7. The system of claim 1, wherein the data elements from amongst the plurality of data elements not identified as confidential data elements are not encrypted using the cryptographic logic and wherein the data block that is stored in the one or more of the plurality of storage devices comprising the SAN includes the encrypted confidential data elements and other unencrypted data elements.

8. The system of claim 1, wherein the smart contract further includes cryptographic keys for the cryptographic logic, wherein upon receipt of the data set by the receiving entity, the receiving entity accesses the smart contract to retrieve one or more of the cryptographic keys and applies the one or more cryptographic keys to the data set to decrypt the encrypted confidential data elements in the data set.

9. A computer-implemented method for inflight security of data transmitted via a Storage Area Network, the computer-implemented method executed by one or more computing device processors and including:
receiving, at one or more generative AI models during data transmission from a sending entity to the SAN, a data block from amongst a plurality of data blocks comprising a data set, the data block comprising a plurality of data elements;
identifying, by the one or more generative AI models, confidential data elements from amongst the plurality of data elements;
categorizing, by the one or more generative AI models, each of the confidential data elements into one of a plurality of confidentiality sectors, each of the confidentiality sectors distinguishable from each other by a different level of transmission protection required;
generating, by the one or more generative AI models for each of the plurality of confidentiality sectors, cryptographic logic that is configured to encrypt and decrypt each of the confidential data elements in a corresponding confidentiality sector;
generating, by the one or more generative AI models, a smart contract exchangeable between the receiving entity and sending entity, wherein the smart contract includes the cryptographic logic for each of the plurality of confidentiality sectors;
encrypting the confidential data elements in the data block using the cryptographic logic specific to the confidentiality sector in which each confidential data element has been categorized in; and
transmitting the data block including the encrypted confidential data elements to a Storage Area Network (SAN) for storage in one or more of the plurality of storage devices prior to transmission to the receiving entity.

10. The computer-implemented method of claim 9, wherein the one or more generative AI models include at least one explainability generative AI model and the computer-implemented method further includes:
generating, by the at least one explainability generative AI model, one or more explanations for at least one of (i) why confidential data elements were categorized in a corresponding one the plurality of confidentiality sectors and (ii) how and why the cryptographic logic was generated for each of the plurality of confidentiality sectors.

11. The computer-implemented method of claim 10, wherein generating the smart contract further includes generating the smart contract, wherein the smart contract further includes the one or more explanations.

12. The computer-implemented method of claim 9, wherein generating the cryptographic logic further includes generating the cryptographic logic based on at least one (i) an overall volume of data elements in the data block, and (ii) a volume of confidential data elements in a corresponding confidentiality sector.

13. The computer-implemented method of claim 9, wherein generating the cryptographic logic further includes generating the cryptographic logic based on a deployment environment in which the data set is to be deployed by the receiving entity.

14. The computer-implemented method of claim 9, wherein generating the smart contract further includes generating the smart contract, wherein the smart contract further includes cryptographic keys for the cryptographic logic, wherein upon receipt of the data set by the receiving entity, the receiving entity accesses the smart contract to retrieve one or more of the cryptographic keys and applies the one or more cryptographic keys to the data set to decrypt the encrypted confidential data elements in the data set.

15. A computer program product including a non-transitory computer-readable medium, the non-transitory computer-readable medium comprising sets of codes for causing one or more computing devices to:
receive, at one or more generative AI models during data transmission from a sending entity to the SAN, a data block from amongst a plurality of data blocks comprising a data set, the data block comprising a plurality of data elements;
identify, by the one or more generative AI models, confidential data elements from amongst the plurality of data elements;
categorize, by the one or more generative AI models, each of the confidential data elements into one of a plurality of confidentiality sectors, each of the confidentiality sectors distinguishable from each other by a different level of transmission protection required;
generate, by the one or more generative AI models for each of the plurality of confidentiality sectors, cryptographic logic that is configured to encrypt and decrypt each of the confidential data elements in a corresponding confidentiality sector;
generate, by the one or more generative AI models, a smart contract exchangeable between the receiving entity and sending entity, wherein the smart contract includes the cryptographic logic for each of the plurality of confidentiality sectors;
encrypt the confidential data elements in the data block using the cryptographic logic specific to the confidentiality sector in which each confidential data element has been categorized in; and
transmit the data block including the encrypted confidential data elements to a Storage Area Network (SAN) for storage in one or more of the plurality of storage devices prior to transmission to the receiving entity.

16. The computer program product of claim 15, wherein the one or more generative AI models includes at least one explainability generative AI model and sets of codes further include a set of codes configured to cause the one or more computing devices to generate, by the at least one explainability generative AI model, explanations for at least one of (i) why confidential data elements were categorized in a corresponding one the plurality of confidentiality sectors and (ii) how and why the cryptographic logic was generated for each of the plurality of confidentiality sectors.

17. The computer program product of claim 16, wherein the set of codes for causing the one or more computing devices to generate the smart contract are further configured to cause the one or more computing devices to generate the smart contract, wherein the smart contract further includes the one or more explanations.

18. The computer program product of claim 15, wherein the set of codes for causing the one or more computing devices to generate the cryptographic logic are further configured to cause the one or more computing devices to generate the cryptographic logic based on at least one (i) an overall volume of data elements in the data block, and (ii) a volume of confidential data elements in a corresponding confidentiality sector.

19. The computer program product of claim 15, wherein the set of codes for causing the one or more computing devices to generate the cryptographic logic are further configured to cause the one or more computing devices to generate the cryptographic logic based on a deployment environment in which the data set is to be deployed by the receiving entity.

20. The computer program product of claim 15, wherein the set of codes for causing the one or more computing devices to generate the smart contract are further configured to cause the one or more computing devices to generate the smart contract, wherein the smart contract further includes cryptographic keys for the cryptographic logic, wherein upon receipt of the data set by the receiving entity, the receiving entity accesses the smart contract to retrieve one or more of the cryptographic keys and applies the one or more cryptographic keys to the data set to decrypt the encrypted confidential data elements in the data set.
